(19) United States
(12) Patent Application Publication
(10) Pub. No.: US 2026/0167122 A1
(43) Pub. Date: Jun. 18, 2026

(54) ELECTRONIC CONTROL UNIT FOR A VEHICLE INTERIOR SURVEILLANCE SYSTEM AND ASSOCIATED INTERIOR SURVEILLANCE SYSTEM

(71) Applicant: Faurecia Clarion Electronics Europe, Paris (FR)

(72) Inventors: Roudhouane BELKHIRI, Paris (FR); Sébastien CAVALLI, Paris (FR)

(21) Appl. No.: 19/423,807

(22) Filed: Dec. 17, 2025

(30) Foreign Application Priority Data
Dec. 18, 2024 (FR) FR 24 14435

(51) Int. Cl. B60R 11/04; H04N 7/18; H04N 13/296; H04N 23/90

(52) U.S. Cl. CPC B60R 11/04; H04N 7/18; H04N 13/296; H04N 23/90

(57) ABSTRACT

A vehicle interior surveillance system that includes a plurality of camera modules and an electronic control unit. The camera modules include a first camera module having a first camera control unit connected to a first serialization module, and at least a second camera module having a second camera control unit connected to a second serialization module. The electronic control unit has a first deserialization module connected to the first serialization module, and a second deserialization module connected to the second serialization module. The electronic control unit further includes a main control device connected to the first and second deserialization modules, and configured to manage, via at least one of the first and second deserialization modules, an activation of each camera module with a time lag with respect to another camera module.

### TECHNICAL FIELD

The present invention relates to an electronic control unit for a vehicle interior surveillance system and an associated vehicle interior surveillance system.

### BACKGROUND

The invention belongs to the field of in-vehicle surveillance systems, which use a plurality of camera modules for general surveillance, such as monitoring the passenger compartment, detecting vital signs, detecting the position of the driver and occupants or locating them.

Each camera module used in such an in-vehicle surveillance system generally comprises a light source and an image sensor.

Such a system, such as the driver monitoring system (DMS) or the occupant monitoring system (OMS), can be used, for example, in advanced driver assistance systems (ADAS).

For effective surveillance inside the vehicle, in all conditions, including night driving, it is useful to activate a light source sensitively at the same time as the image sensor in order to capture one or more images, forming a video, of the vehicle interior. For example, in some applications, in order to avoid disturbing the driver, light sources in a spectrum other than visible light, such as infrared light sources, are used. However, for infrared or visible light sources, the activation of a light source from a given camera module, even for a short period of time, can disrupt the acquisition of images by another camera module, by introducing unwanted reflections or over-illumination into images captured by another camera module.

### SUMMARY

The present invention aims to remedy the aforementioned problem.

To this end, the invention proposes an electronic control unit for a vehicle interior surveillance system, the interior surveillance system comprising a plurality of camera modules comprising:
a first camera module, comprising a first light source and a first image sensor, the first camera module comprising a first camera control unit, connected to a first serialization module,
at least a second camera module, comprising a second light source and a second image sensor, the second camera module comprising a second camera control unit, connected to a second serialization module,
the electronic control unit comprising a first deserialization module connected to the first serialization module, and at least a second deserialization module each connected to each of the corresponding at least one second serialization module, the electronic control unit further comprising a main control device connected to said first and second deserialization modules, the electronic control unit being configured to manage, via at least one of said first and second deserialization modules, an activation of each camera module with a time lag with respect to another camera module.

Advantageously, the proposed electronic control unit makes it possible to control the activation sequence of the camera modules of the plurality of camera modules, so as to avoid the simultaneous activation of the light sources of two separate camera modules, and therefore to ensure that the image acquisition quality is satisfactory under all conditions.

In some embodiments of the invention, the electronic control unit comprises one or more of the following features, considered alone or according to any technically feasible combinations.

The main control device is configured to activate the first camera module, via a first trigger signal, sent via the connection between the first deserialization module and the first serialization module, to trigger the first camera control unit in order to activate the first light source and the first image sensor.

The first deserialization module is further configured to receive a synchronization signal from the first serialization module and to transmit the synchronization signal to a second deserialization module, said second deserialization module being configured to transmit said synchronization signal to the corresponding second serialization module of a second camera module, said second camera module being configured, upon receipt of said synchronization signal, to obtain a delayed second trigger signal of said time lag, the second trigger signal being applied to activate said second camera module.

Each second deserialization module is configured to receive a synchronization signal from the connected second serialization module, and to transmit the synchronization signal to a subsequent second deserialization module connected to a subsequent second camera module, said subsequent second camera module being configured, on receipt of said synchronization signal, to obtain a subsequent second trigger signal delayed by said time lag, the subsequent second trigger signal being applied to activate said subsequent second camera module.

The first deserialization module and at least a second deserialization module are connected via an LVDS (Low Voltage Differential Signaling) link.

The interior surveillance system comprises a plurality of second camera modules and the main control device is configured to:
generate a first trigger signal to activate the first camera module, and send the first trigger signal to activate the first camera module via the first deserialization module, and
generate at least a second trigger signal to activate the or each second camera module, each second trigger signal being delayed with respect to the first trigger signal by an overall lag, the overall lag depending on the rank of the second camera module in the plurality of second camera modules, and send each second trigger signal via the corresponding second deserialization module to activate the second camera module.

The main controller sends each of said first and second trigger signals to a general input/output port, GPIO, of the corresponding first camera module and second camera module, via a GPIO port of the corresponding first and second deserialization module.

The main control device sends each of said first and second trigger signals as I2C (Inter Integrated Circuit) commands.

The invention also relates to a vehicle interior surveillance system comprising a plurality of camera modules comprising:
a first camera module, comprising a first light source and a first image sensor, the first camera module comprising a first camera control unit, connected to a first serialization module,
at least a second camera module, comprising a second light source and a second image sensor, the second camera module comprising a second camera control unit, connected to a second serialization module,
the interior surveillance system further comprising an electronic control unit as briefly described hereinbefore.

According to an optional feature, the first light source and/or each second light source is an infrared light source.

### BRIEF DESCRIPTION OF THE DRAWINGS

Other features and advantages of the present invention will become apparent in light of the following description, provided solely by way of non-limiting example, referring to the appended drawings, wherein:

FIG. 1 schematically shows the main functional modules of a vehicle interior surveillance system according to the invention;

FIG. 2 schematically shows a vehicle interior surveillance system according to a first embodiment;

FIG. 3 schematically shows a vehicle interior surveillance system according to a second embodiment, and

FIG. 4 schematically shows a vehicle interior surveillance system according to a third embodiment.

### DETAILED DESCRIPTION

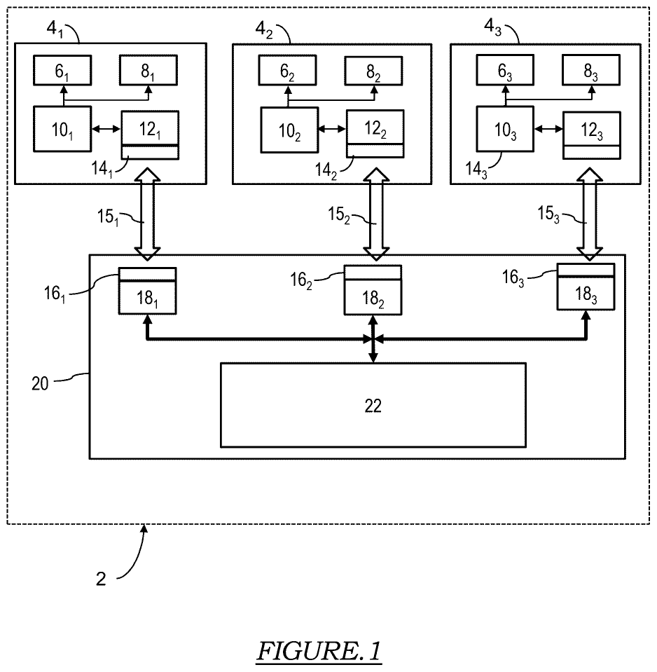

FIG. 1 is a schematic depiction of an interior surveillance system 2 of a vehicle (not shown), referred to as “system 2” in the following description.

System 2 is suitable for all types of vehicle, especially cars.

System 2 comprises a plurality of on-board camera modules, comprising a first camera module 4₁ and at least a second camera module 4₂.

In the example shown in FIG. 1, the system 2 comprises a first camera module 4₁ and two second camera modules 4₂, 4₃.

In the general case, the plurality of camera modules can comprise any number N of camera modules 4₁ to 4_{N}. In the examples shown, N=3.

Each camera module has an associated rank in the plurality of camera modules, for example the first camera module 4₁ has rank 1, the second camera module 4₂ has rank 2, the second camera module 4₃ has rank 3, and more generally, the second camera module 4_{N} has rank N.

Each camera module 4₁ to 4_{N} comprises a light source 6₁ . . . 6_{N}, an image sensor 8₁ . . . 8_{N}, a camera control unit 10₁ . . . 10_{N} and a serialization module 12₁ . . . 12_{N}, which are adapted to communicate via an internal communication bus.

According to one embodiment, each camera module further comprises at least one connection port 14₁ . . . 14_{N}, associated with the serialization module 12₁ . . . 12_{N}, for example a General Purpose Input/Output (GPIO) connection port and/or an Inter-Integrated Circuit (I2C) connection port.

For the first camera module, the light source 6₁ may also be referred to as the first light source, the image sensor 8₁ may also be referred to as the first image sensor, the camera control unit 10₁ may also be referred to as the first camera control unit, the serialization module 12₁ may also be referred to as the first serialization control module, and the connection port 14₁ may also be referred to as the first connection port.

For each second camera module, the light source module may also be referred to as the second light source module, the image sensor may also be referred to as the second image sensor, the camera control unit may also be referred to as the second camera control unit, the serialization module may also be referred to as the second serialization control module, and the connection port may also be referred to as the second connection port.

According to one example, some or all of the light sources 6₁ . . . 6_{N} comprise one or more light-emitting diodes (LEDs). According to a particular example, each light source 6₁ . . . 6_{N} is configured to emit light in a spectrum other than the visible light spectrum, such as the infrared light spectrum. In other words, according to one example, each light source 6₁ . . . 6_{N} is an infrared light source.

Each light source 6₁ . . . 6_{N} and each image sensor 8₁ . . . 8_{N} are configured to be activated (that is, switched on) by the corresponding camera control unit 10₁ . . . 10_{N}.

Each serialization module 12₁ . . . 12_{N} is configured to receive image/video data on a video input interface (not shown), the image/video data being represented as a series of pixel matrices, and to transform the image/video data into a series of bits.

Each of the plurality of camera modules 4₁ . . . 4_{N} is configured to communicate via a serial link 15₁ . . . 15_{N} with a corresponding deserialization module 18₁ . . . 18_{N}, each deserialization module 18₁ . . . 18_{N} having an I/O connection port 16₁ . . . 16_{N}.

According to one embodiment, each serial link 15₁ . . . 15_{N} is a physical LVDS (Low Voltage Differential Signaling) or Coax link, generally used for cameras.

According to one embodiment, each serial link 15₁ . . . 15_{N} is a Gigabit Multimedia Serial Link (GMSL) or a Flat Panel Display Link (FPD-Link), for example GMSL1, GMSL2, FPD-Link3, FPD-Link4.

For example, each serialization module is a standard component, such as a CSI-2 (Camera Serial Interface 2) serializer to GMSL or FPD-Link.

System 2 further comprises an electronic control unit 20, comprising a main control device 22. The main control device 22 is preferably implemented as a system-on-a-chip (SoC) and is configured to communicate, via a bidirectional communication bus, with each deserialization module 18₁ . . . 18_{N}.

Preferably, the electronic control unit 20 comprises deserialization modules 18₁ . . . 18_{N}, and the main control unit 22.

The deserialization module 18₁, connected to the serialization module 12₁ of the first camera module, is also referred to as the first deserialization module.

Each deserialization module 18₂ . . . 18_{N}; connected to a corresponding serialization module 12₂ . . . 12_{N} of a second camera module 4₂ to 4_{N} can also be referred to as a second deserialization module.

Advantageously, the electronic control unit 20 is configured to manage, via the first deserialization module 18₁ or via the plurality of deserialization modules 18₁ . . . 18_{N}, the activation of each camera module with a time lag with respect to another camera module.

The activation of a camera module comprises the activation of the light source, that is, switching on the light source, and activating the image sensor of the camera module.

The activation of a given camera module is followed by its deactivation (in particular, its light source is switched off) before any other camera module of the plurality of camera modules is activated.

The time lag is selected so that only one light source is activated at a time. In other words, when a light source of one camera module is switched on, all other light sources of the other camera modules are switched off.

For example, the time lag D between the activation of two successive cameras of the plurality of cameras depends on the FPS (frame per second) parameter of each camera, for example less than or equal to 10 ms.

Advantageously, the electronic control unit 20 manages the sequential activation of the camera modules, which avoids any interference between the light sources of separate camera modules.

The time lag D ensures that when a subsequent camera is activated (that is, its light source is switched on), the previous camera is deactivated (that is, its light source is switched off).

For example, the order in which camera modules are activated is the ranking order.

For example, when the first (rank 1) camera module is activated first, the overall time lag between the activation of the first camera module 4₁ and the activation of the second camera module 4₂ (rank 2 camera module) is D, the overall time lag between the activation of the first camera module 4₁ and the activation of the second camera module 4₃ (rank 3 camera module) is 2×D, and so on, so that the overall time lag between the activation of the first camera module 4₁ and the activation of the second camera module 4_{N} (rank N camera module) is (N−1)×D.

Consequently, the overall time lag between the activation of the first camera module and the activation of a given second camera module depends on the rank of the second camera module in the plurality of camera modules.

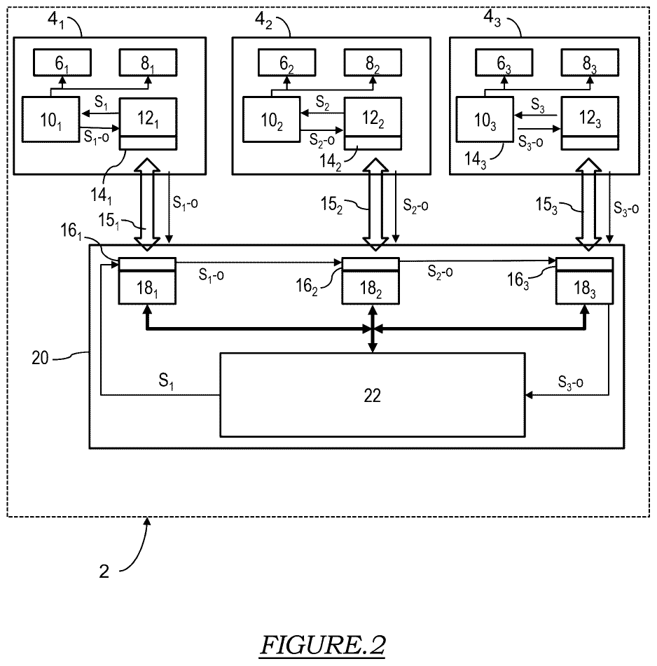

Several embodiments to manage the sequential activation of camera modules are disclosed below referring to FIGS. 2 to 4.

According to a first embodiment, shown schematically in FIG. 2, the main control device 22 is configured to activate the first camera module 4₁, via a first trigger signal S₁ which is sent to the first deserializer 18₁. The deserializer 18₁ transmits the first trigger signal S₁ via, for example, its GPIO port, and then via the serial link 15₁ to the corresponding serialization module 12₁.

In this first embodiment, the first camera module 4₁ acts as the main synchronization module, and the synchronization of the activation of the second camera modules is then performed in cascade.

On receipt of the first trigger signal S₁, the first serialization module 12₁ transmits the first trigger signal S₁ to the first camera control unit 10₁, which then activates the first light source 6₁ and the first sensor 8₁. After the acquisition of images by the first sensor 8₁, the first light source 6₁ is switched off, the first camera control unit 10₁ is further configured to generate a return synchronization signal S₁-o, which is transmitted via the first serialization module 12₁ and the serial link 15₁ to the first deserialization unit 18₁.

The first deserialization unit 18₁ is configured to receive the synchronization signal and to transmit said synchronization signal via, for example, its GPIO port to a second deserialization module of a selected second camera module, for example the second camera module 4₂, of rank 2 in the plurality of camera modules.

The second camera module 4₂ is configured to receive the synchronization signal S₁-o, to add, for example, a time lag D by the second camera control unit 10₂ to the received synchronization signal to obtain a second trigger signal S₂, the second trigger signal being applied to activate the second camera module 4₂.

After the acquisition of images by the second sensor 8₂, the second camera control unit 10₂ is also configured to generate a return synchronization signal S2-o, which is transmitted via the second serialization module 12₂ and the serial link 15₂ to the second deserialization unit 18₂.

When the system comprises a plurality of second camera modules, the operations are repeated sequentially, according to a predetermined order of activation of the second camera modules, for example according to their corresponding rank.

According to one embodiment, considering any two successive camera modules 4ₖ and 4ₖ₊₁, the second deserialization module 18ₖ is configured to receive the synchronization signal Sₖ-o from the second serialization module 12ₖ, via the serial link 15ₖ.

The second deserialization module 18ₖ is configured to transmit the synchronization signal to the second deserialization module 18ₖ₊₁. The second deserialization module 18ₖ₊₁ is then configured to transmit the synchronization signal to the corresponding serialization module 12ₖ₊₁ of the camera module 4ₖ₊₁.

The second camera module 4ₖ₊₁ is configured to receive the synchronization signal Sₖ-o, to add, for example, the time lag D to the received synchronization signal in order to obtain a second trigger signal Sₖ₊₁, the second trigger signal being applied to activate the second camera module 4ₖ₊₁. When the acquisition of images is completed by the last camera module, the synchronization signal S₃-o is sent back to the main control device 22.

Advantageously, the first embodiment comprises only hardware communications using serial communication links.

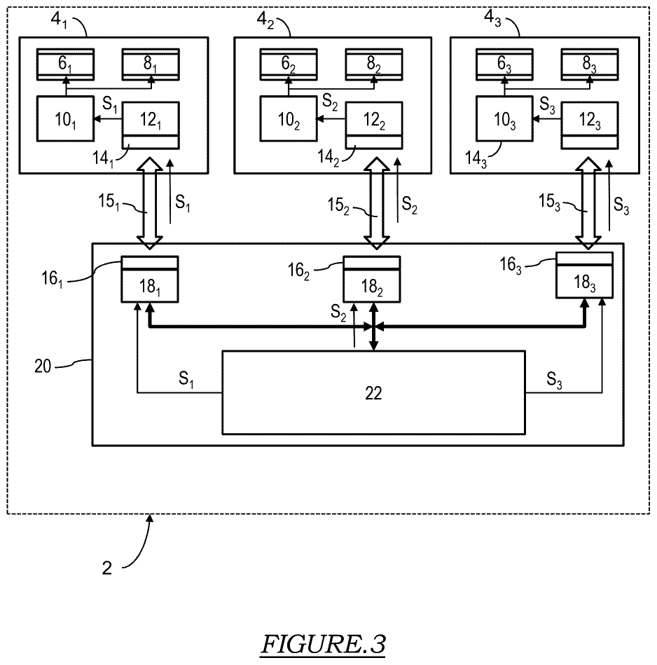

According to a second embodiment, shown in FIG. 3, the main control device 22 is configured to generate successive trigger signals S₁ to S_{N} to successively activate each of the camera modules 4₁ to 4_{N}, according to a predetermined order, respectively a first trigger to activate the first camera module and a plurality of successive second trigger signals to successively activate the plurality of second camera modules. Each camera module is activated for a given period of time at most equal to the time lag D.

More generally, two successive trigger signals Sₖ and Sₖ₊₁ are generated by applying the time lag D, and sent to the respective corresponding deserialization modules 18ₖ and 18ₖ₊₁.

Each deserialization module is configured to transmit the trigger signal to the corresponding serialization module in order to activate the corresponding camera module.

According to the second embodiment, the trigger signals S₁ . . . S_{N} are transmitted via the General Purpose Input/Output (GPIO) connection ports which connect the deserialization module 18₁ . . . 18_{N} and the serialization module 12₁ . . . 12_{N} corresponding to each camera module 4₁ . . . 4_{N}. Each serialization module 12₁ . . . 12_{N} sends, upon receipt, the trigger signal to the camera control unit 10₁ . . . 10_{N} to activate the camera module.

Advantageously, in this second embodiment, the delay of the trigger signals is managed by the main control device, so no management synchronization signal in the camera modules is required. As a result, the management of the activation camera modules is assured even if an error occurs in one of the camera modules of the plurality of camera modules.

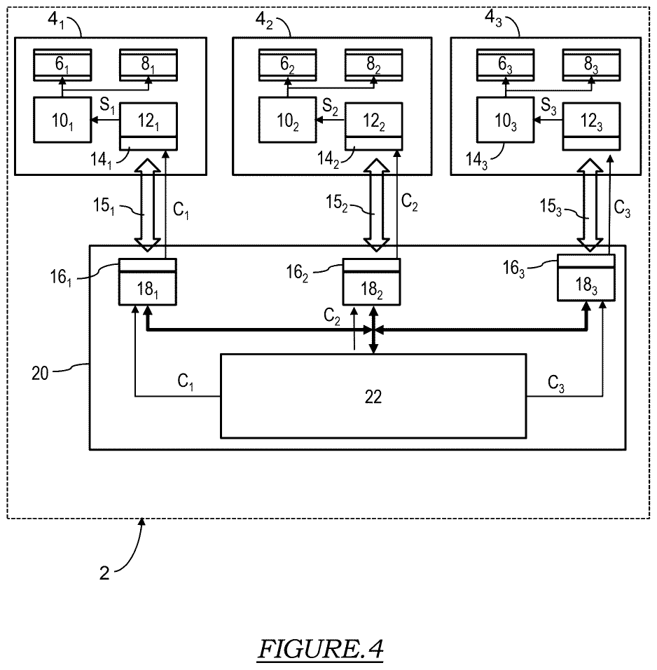

According to a third embodiment, shown in FIG. 4, the main control device 22 is configured to generate successive trigger signals C₁ to C_{N} to activate each of the camera modules 4₁ to 4_{N} in succession, according to a predetermined order. Each camera module is activated for a given period of time at most equal to the time lag D.

In this embodiment, the trigger signals generated are in the form of I2C (“Inter-Integrated Circuit”) commands which are transmitted via the I2C connection ports of deserialization modules 18₁ . . . 18_{N} to the corresponding I2C connection ports of serialization modules 12₁ . . . 12_{N} of camera modules 4₁ . . . 4_{N}. Each serialization module 12₁ . . . 12_{2N} is configured to send, on receipt, a data adjustment signal S₁ . . . S_{N} to camera control unit 10₁ . . . 10_{N} in order to activate the camera module.

As in the second embodiment, two successive trigger signals Cₖ and Cₖ₊₁ are generated by applying the time lag D and sent to the respective corresponding deserialization modules 18ₖ and 18ₖ₊₁.

Advantageously, in this third embodiment, the delay of the trigger signals is managed by the main control device, without the need to manage the time lag in the camera modules. As a result, the management of the activation camera modules is assured even if an error occurs in one of the camera modules of the plurality of camera modules.

1. An electronic control unit for a vehicle interior surveillance system that comprises a plurality of camera modules comprising: a first camera module, comprising a first light source and a first image sensor, the first camera module comprising a first camera control unit, connected to a first serialization module; and at least a second camera module, comprising a second light source and a second image sensor, the second camera module comprising a second camera control unit, connected to a second serialization module, the electronic control unit comprising:
a first deserialization module that connects to the first serialization module, and one or more second deserialization modules each connected to a corresponding one of the one or more second serialization modules, the electronic control unit further comprising a main control device connected to said first and second deserialization modules, the electronic control unit being configured to manage, via at least one of said first and second deserialization modules, an activation of each camera module with a time lag with respect to another camera module.

2. The electronic control unit according to claim 1, wherein the main control device is configured to activate the first camera module, via a first trigger signal, sent via the connection between the first deserialization module and the first serialization module, to trigger the first camera control unit in order to activate the first light source and the first image sensor.

3. The electronic control unit according to claim 2, wherein the first deserialization module is further configured to receive a synchronization signal from the first serialization module, and to transmit the synchronization signal to a second deserialization module, said second deserialization module being configured to transmit said synchronization signal to the corresponding second serialization module of a second camera module, said second camera module being configured, upon receipt of said synchronization signal, to obtain a second trigger signal delayed by said time lag, the second trigger signal being applied to activate said second camera module.

4. The electronic control unit according to claim 3, the interior surveillance system comprising a plurality of second camera modules, and each second deserialization module being configured to receive a synchronization signal from the connected second serialization module, and to transmit the synchronization signal to a subsequent second deserialization module connected to a subsequent second camera module, said subsequent second camera module being configured, upon receipt of said synchronization signal, to obtain a subsequent second trigger signal delayed by said time lag, the subsequent second trigger signal being applied to activate said subsequent second camera module.

5. The electronic control unit according to claim 2, wherein said first deserialization module and at least one of said one or more second deserialization modules are connected via a low voltage differential signaling link.

6. The electronic control unit according to claim 1, wherein the main control device is configured to:
generate a first trigger signal to activate the first camera module, and send the first trigger signal to activate the first camera module via the first deserialization module, and
generate at least a second trigger signal to activate the or each second camera module, each second trigger signal being delayed with respect to the first trigger signal by an overall time lag, the overall time lag depending on a rank of the second camera module in the plurality of camera modules, and send each second trigger signal via the corresponding second deserialization module to activate the or each second camera module.

7. The electronic control unit according to claim 6, wherein the main control device sends each of said first and second trigger signals to a respective general input/output port, GPIO, of the corresponding first camera module and second camera module, via a respective GPIO port of the corresponding first and second deserialization module.

8. The electronic control unit according to claim 6, wherein the main control device sends each of said first and second trigger signals in the form of Inter-Integrated Circuit commands.

9. A vehicle interior surveillance system comprising the electronic control unit according to claim 1 and the plurality of camera modules.

10. The interior surveillance according to claim 9, wherein the first light source and/or each second light source is an infrared light source.
